(19) United States
(12) Patent Application Publication
(10) Pub. No.: US 2023/0119381 A1
(43) Pub. Date: Apr. 20, 2023

(54) Power Generation And Storage Apparatus

(71) Applicant: Grafmarine Ltd, Altrincham (GB)

(72) Inventor: Martin Leigh, Altrincham (GB)

(73) Assignee: Grafmarine Ltd, Altrincham (GB)

(21) Appl. No.: 17/928,880

(22) PCT Filed: May 28, 2021
(86) PCT No.: PCT/GB2021/051313

§ 371 Date: Nov. 30, 2022

(30) Foreign Application Priority Data
Jun. 1, 2020 (GB) 2008192.3

(51) Int. Cl. H01G 9/28; H02J 7/35; H02J 3/38; H02J 3/32; H02J 15/00; H01G 11/10; H01G 15/00; H01M 16/00; H01M 50/227; H01M 50/229; H01M 50/222; B63B 35/44

(52) U.S. Cl. CPC H01G 9/28; H02J 7/35; H02J 3/381; H02J 3/32; H02J 15/008; H01G 11/10; H01G 15/00; H01M 16/006; H01M 50/227; H01M 50/229; H01M 50/222; B63B 35/44; H02J 2300/24; H02J 2207/50; H02J 2300/30; H01G 9/2077

(57) ABSTRACT

The present invention relates to an apparatus and method for the localized capture, storage and specialized use of power generated from natural sources, such as solar power or hydropower. The apparatus can be used, for example, or in or near commercial or residential buildings, vehicles, marine vessels, a wind farm turbine tower, or in a solar park or photovoltaic power station, or anywhere there is a requirement for localized power generation, localized storage and wider distribution of power.

The present invention relates to an apparatus for the generation, storage and management of electricity derived from natural sources, such as solar power or hydropower. The apparatus can be used, for example, on or in or near commercial or residential buildings, vehicles, marine vessels, a wind farm turbine tower, in a solar park or photovoltaic power station, or anywhere there is a requirement for localized power generation, localized storage and wider distribution of power, and energy management within the layout of, or beyond, an area containing the apparatus.

### BACKGROUND OF THE INVENTION

There are many types of apparatuses which are able to capture the energy from natural sources, such as solar power or hydropower, convert it into electrical energy, and store it.

One such class of apparatuses includes those containing perovskite materials. Perovskite is a calcium titanium oxide mineral composed of calcium titanate (CaTiO₃). The term ‘perovskite’ is also used to refer to the class of chemical compounds which have the same type of cubic crystal structure as CaTiO₃. They generally have the chemical formula ABX₃, where ‘A’ and 13′ represent cations and X is an anion that bonds to both cations.

Perovskites are also desirable due to their relatively simple manufacturing processes.

However, there is always a desire to provide new devices for energy conversion.

Therefore, in accordance with the invention, there is provided an apparatus for the conversion of power from a natural energy source into electricity, and the storage and distribution of the electricity, the apparatus comprising:
i) one or more first devices able to convert power from a natural energy source into electricity;
ii) one or more second devices able to store the electricity generated by the one or more first devices;
iii) a third device able to direct the electricity from the one or more first devices to the one or more second devices;
iv) a fourth device able to distribute the electricity from the apparatus.

The apparatus of the invention may be used for the generation of electricity from solar power or from hydropower.

The apparatus of the invention may be used anywhere that has a requirement for power generation and storage, such as in, on, or near residential or commercial buildings, functional structure or vehicles, marine vessels, or a wind farm turbine tower or, in a solar park or photovoltaic power station, or anywhere there is a requirement for localized power generation, localized storage and wider distribution of power.

When in use, one or more of the apparatuses may be employed.

One potential location for the use of the one or more apparatuses is on a marine vessel, which may be anything from a smaller boat, or a yacht, to a larger vessel such as a cargo ship, tanker, or cruise liner. The one or more apparatuses may be installed on any exposed surface of the vessel, such as the deck, or on the side of the vessel, or on a cabin roof, or anywhere else which may be exposed to the necessary elements, such as the sun or water, which might be considered suitable for energy generation. If the apparatus is to be used on a larger vessel, then it is typically designed to have a greater storage capacity than would be employed for an apparatus for use on a smaller vessel, in view of the greater power requirements of the larger vessel. This may take the form of a stack where additional electrical storage will be added to provide additional battery, supercapacitor, or hybrid storage. The height of the apparatuses will be proportional to the amount of storage they supply, i.e. a taller apparatus signifies a greater level of energy storage.

The first, second, third and fourth devices in the invention will now be discussed in greater detail.

### First Device

According to one embodiment of the invention, the one or more first devices are able to convert energy from a natural source, such as solar power or hydropower, into electricity. For this, they may comprise any device(s) that is/are able to convert energy from a natural source such as solar power or water, into electricity. One example of such devices comprises one or more solar or photovoltaic (PV) cells. PV cells are also able to generate hydrogen from water, by providing the power for electrolysis.

Alternatively, a metamaterial (i.e. a material that is engineered to have a property that is not found in naturally occurring materials) that can absorb visible and infra-red frequencies, can also capture energy from the sun. Non-limiting examples of such materials include a graphene material formed using chemical vapour deposition (CVD), or a combination of 3-dimensional coating materials.

The one or more first devices may constitute a first layer in the apparatus.

In one embodiment of the invention, the one or more first devices may comprise a 2-dimensional material—which may be inkjet printed—that is able to convert energy as a PV cell. This PV cell may comprise, for example, one or more selected from layers of perovskite, carbon paste, noble metals and/or conductive films.

The one or more first devices may comprise a backplate, which may be electrically conductive, and may comprise one or more materials selected from carbon nano tubes (which may be single layers or multiple layers), boron nitride, graphene, graphene oxide, or any combination of these materials. The back plate may be part of a larger sealed component with polymer based covered film, or resin coating where needed.

The one or more first devices, such as PV cells, may be coated with a conductive material, such as but not limited to, a graphene oxide material, such as a graphene oxide paste.

The PV cells may be printed directly onto the backplate and then sealed with a conductive polymer film, before being covered again for protection from the environment.

When there is a plurality of first devices, such as PV cells, in the apparatus, they may be arranged in any pattern or formation as desired, and may be made into bespoke shape(s) which are linked together as a circuit to pass generated electricity through one side of one first device to an adjacent device. The final design arrangement for the plurality of first devices is dependent on the size of the apparatus and the type of first device used for that particular requirement.

According to one embodiment, the plurality of first devices may be arranged in rows, which may be substantially parallel. Alternatively, the plurality of first devices may be positioned in small clusters with a number of them in close proximity to each other in different sections (there may be two, three, four, or more sections) of the first layer comprising the one or more first devices.

The one or more first devices, such as PV cells, may be coated with a conductive material, such as but not limited to, a graphene oxide material, such as a graphene oxide paste.

The PV cells may be printed directly onto the backplate and then sealed with a conductive polymer film, before being covered again for protection from the environment.

When the apparatus of the invention is generating electricity using water power or water vapour, the apparatus may have a hydrogen producing cell which uses photovoltaic technology and heat to create hydrogen, and thus electricity, from water. The apparatus may also store the hydrogen in a metallic structure made of a metallic oxide, or of a metallic oxide with graphene. If the apparatus is used for hydrogen generation, the hydrogen produced may be stored under the PV cells.

The water is sourced from a river or sea, and may be filtered, such as by graphene filtration; or it may be collected by condensation in the form of water vapour from the air. Such a filter may therefore be present as part of the first device.

The apparatus typically may comprise a protective layer. The protective layer is also typically the layer which is uppermost in the apparatus of the invention when the apparatus is in use, proximal to the natural energy source, and which will be exposed most to the elements and, potentially, human contact. It is also the layer which will be walked upon when the apparatus is located on a floor or decking surface, and therefore needs to be sufficiently sturdy to be walked upon without fracturing and breaking, while simultaneously also being relatively lightweight, durable, and resistant to scratching and extreme temperature conditions, and also substantially slip-resistant. Therefore, according to another embodiment, the protective layer is provided with non-slip characteristics, in order that people walking thereon do not slip and fall. Examples of such non-slip characteristics include, but are not limited to, raised protrusions, optionally in the form of patterns, which can be random or repeated, regular or irregular, which may be shaped overall in a concave or convex surface across each device, and which can permit a larger coefficient of friction and thus grip, or pieces of a particulate material embedded in the layer, which provide a rougher surface, and therefore also a larger coefficient of friction. These non-slip area patterns may also act as light guides that prevent light escaping from inside the apparatus. The protective layer may also have a light scattering or non-reflective coating.

In one embodiment, the protective layer may be a separate entity to the one or more first devices of the invention. Alternatively, in another embodiment, the protective layer may comprise part of the first device, and contain within it the one or more of the one or more first devices which are able to convert power from a natural energy source into electricity.

In another embodiment, the one or more first devices may be located underneath the protective layer. For example, the one or more first devices may be affixed to an underside of the protective layer or be located just underneath the protective layer.

The devices may be bonded onto the protective layer by any suitable means, such as by adhesive or suitable stable conductive backing material.

In either of these embodiments, whether it does or does not contain within it the one or more first devices which are able to convert power from a natural energy source into electricity, while protecting the one or more first devices and the rest of the apparatus from damage, the protective layer is designed to allow the one or more first devices able to convert power from a natural energy source into electricity to be exposed to the natural energy source in order that they are able to generate the electricity.

The protective layer must therefore comprise a material that is able to allow this. For example, in the case of solar energy, the protective layer needs to be pervious to solar energy. In some embodiments, the protective layer is visually transparent, and/or pervious to solar radiation. The protective layer may comprise, or be formed from, materials such as a resin, fiberglass, toughened glass, or a hardened polymer, such as a silicon-based polymer, polycarbonate, or poly(methyl methacrylate), which is marketed under the trade names Plexiglas® or Perspex®. It may also be any mixture of materials that imparts multi-purpose enhancement, such as those which are able to provide characteristics such as non-slip and durability. According to one embodiment, the protective layer may comprise a substantially transparent polycarbonate or glass, or a combination of both as a composite material.

The one or more first devices may be flat ink jet-printed or screen-printed, or they may be 3D printed. They may comprise a plastic foil base or similar, and, for example, employ the use of perovskite crystallization. The presence of some perovskite material in the one or more devices enables them to absorb twice as much energy from the same spectrum of light. A PV cell, for example, is usually able to absorb about 15-18% of the solar energy; however, in the presence of perovskite material, between 30-50% can be absorbed, which in turn means that a greater amount of electricity can be generated. The one or more first devices may also include the use of carbon or graphene nanotubes as part of their structure, produced either on a copper layer or as part of a sandwich of materials to harvest solar energy.

The protective layer may also comprise a three-dimensional structure thereon, or a pattern. These may be created by way of, for example, a laser cut, etching or hot press. The presence of such a three-dimensional structure or pattern enables a magnification of the light entering the apparatus, and also a diffusion of the light exiting the apparatus.

An alternative arrangement of a plurality of first devices is that they may be located on one or more sides of the protective layer, either within it or on an underside thereof. Any collected energy will flow around the edges of the device array designed within the device layout, with the ability to bypass any of the individual devices should they become inoperable or be damaged beyond normal use, being avoided through the design of the device arrangement.

### Second Device

The one or more second devices are able to store the electricity which is generated by the one or more first devices.

Typically, when the natural energy source being converted into electricity is solar power, the one or more second devices able to store the electricity generated by the one or more first devices comprise one or more batteries, or a combination of a one or more supercapacitors and one or more batteries as a hybrid alternative. The batteries may be of any type deemed suitable by a skilled person. The one or more supercapacitors may comprise one or more of the following non-limiting materials: one or more perovskite compounds, one or more metal oxides (such as indium tin oxide, fluorine tin oxide, aluminium-doped tin oxide, ruthenium oxide, iridium oxide, zinc oxide, copper oxide, manganese oxide, and/or nickel oxide), and may also comprise nanotubes of a conductive material or metal, such as carbon nanotubes or nanotubes made using copper, nickel or cobalt. If desired, an amount of bismuth may also be added to speed up the anode/cathode interaction; this may be in an elemental form or as a compound.

Examples of perovskite compounds which may be used in the apparatus of the invention include, but are not limited to, BaTiO₃, (Ba,Sr)TiO₃, Pb(Zr,Ti)O₃, Bi₄Ti₃O₁₂, (K_{0.5}Na_{0.5})NbO₃, Na_{0.5}Bi_{0.5}TiO₃, (Pb,La)(Ti,Zr)O₃, BiFeO₃, PbMg_{⅓}Nb_{⅔}O₃, SrRuO₃, (La, A)MnO₃ (where A=Ca, Sr, Ba), SrTiO₃, LaGaO₃, BaIn₂O₅, BaCeO₃, BaZrO₃, (La,Sr)BO₃ (where B=Mn, Fe, Co), LaAlO₃, YAlO₃.

The one or more supercapacitors are chemically able to increase the electrical output relative to that which is generated by the one or more first devices by at least double, and even by up to about 10 times.

The one or more supercapacitors may be located within a housing, such as one made of aluminium. The one or more supercapacitors may have a layered structure, or a fractal structure.

Alternatively, in another embodiment of the invention, when the natural energy source being converted into electricity is hydropower, the battery and supercapacitor used in the solar power conversion embodiment is replaced with a hydrogen storage device, such as one or more metal oxide structures, which store the hydrogen generated from the water. The metal oxides may include, but are not limited to, manganese oxide, indium tin oxide, fluorine tin oxide, aluminium-doped tin oxide, ruthenium oxide, iridium oxide, zinc oxide, copper oxide, and/or nickel oxide).

### Third Device

The third device is able to direct the electricity from the one or more first devices to the one or more second devices. In one embodiment, it may comprise a printed circuit board (PCB), which manages and directs any harvested energy into the one or more second devices for the storage of the generated electrical power. The third device may employ a supercapacitor, or a combination of a supercapacitor and battery advanced technologies as a hybrid alternative.

The sensing and management of this power may be reported to a centralised or specialized control unit, which can either be accessed through a smart phone app, or can be used with inbuilt navigation panels within an existing ship structure, such as on the instrument panel via a liquid crystal display (LCD) screen. Sensors on the third device will record and regulate the level of power within the one or more second devices, and they will measure available power and provide information of how long this power can be used at its current discharge rate. For example, when the one or more second devices comprise one or more batteries, there will typically a minimum of two recharges for any battery cells per 24-hour cycle, or a cumulative charge for the supercapacitor until the energy is released for use.

The third device can also act as a gateway for the collection of the harvested electricity within each apparatus, as it can also control the flow of energy to be spread across an area to be used as where and when required. It also provides a safety break point for the detection of irregular temperature occurrences at a very local level before it causes a problem. An overall management cell also contains the emergency gateway shut off point for any part's failure, overheating, or over-charging of any electricity storage device, and this is controlled through the third device.

### Fourth Device

The fourth device enables the distribution of electricity from the apparatus to wherever requires it, i.e. it acts as an energy distribution device, or as an energy layer.

The fourth device comprises one or more electrically conductive materials. Non-limiting examples of such materials may include one or more of an electrically conductive metal, such as copper, nickel and/or a composite alloy of two or more electrically conductive metals such as copper and nickel; or graphene, a conductive polymer. The electrically conductive metal may be in the form of a mesh or foil structure. The graphene may be applied to both sides of the metal, whatever form it is in. The metallic layer may be coated in a corrosion inhibitor material, such as a graphene inhibitor, a chromate-based inhibitor, a phosphate-based inhibitor, or an organic ion in an ion-exchange resin; or an active, which may be added on to the metallic layer as a paint.

The composite alloy may be made of known powdered metals, such as rare earth magnetic metals, copper, copper oxide, cobalt and nickel metals, where many of the occurring impurities are removed and oxides are reduced from the metals through advanced production techniques. The composite alloy may also contain an amount of graphene. These may then be combined into a weave and coated in a nano-rubberised and weather resistant material(s), to form a flexible (or non-rigid) conductive structure, such as a mesh structure. The metals can be additive manufactured (AM) to encase a layer of a conductive metal, and then powder coated with a conductive material such as graphene, to provide the maximum resistance to the harsh environment the apparatus will operate in.

The composite alloy may be created with a high concentration of metal-based materials mixed as nano-sized powders and then printed, effectively maintaining their properties at molecular level, at any size or shape, retaining the composite qualities at each size. These molecular composites may contain a high level of magnetism, and can facilitate highly efficient electrical transmission by magnetism or electromagnetism, to facilitate the flow of electrical power.

In one embodiment, the fourth device may comprise three sub-layers. A first sub-layer is an electrically conductive layer. This layer may be positioned, or sandwiched, between a second sub-layer and a third sub-layer, each of which sub-layers may comprise an electrically and thermally non-conductive (or minimally conductive) material. The second and third sub-layers may comprise the same materials, or they may comprise different materials. This non-conductive (or minimally conductive) material may be, or comprise, any suitable lightweight non-conductive material, such as for example, a resin composite material.

The conductive layer may comprise a composite alloy material comprising one or more of a rare earth magnetic metal, copper, copper oxide, graphene, graphene oxide, cobalt, nickel, and/or an electrically conductive polymer. The composite alloy may be in the form of a weave, which may be encased or coated by a mixture of a polymer (such as rubber) and graphene.

This conductive layer can be produced in a small or large sheet form to be anchored centrally within the apparatus to provide flexibility and movement tolerance, while still being able to provide consistent levels of conductivity across the energy distribution devices of a plurality of electrically connected apparatuses.

The conductive layer may also have one or more sensors located thereon, in order to be able to continually or periodically monitor the conductivity of the conductive sub-layer over time for any variation. The one or more sensors may be connected to software and/or hardware, which may include, for example but not exclusively, a laptop computer or smart phone, from which the relevant information can be accessed.

The first, second third and fourth devices of the apparatus of the invention may be arranged therein in any way suitable for the generation and storage of electrical power derived from a natural source, such as solar energy.

However, in one embodiment of the invention, the apparatus of the invention may have a layered arrangement. In one embodiment, the one or more first devices form a first layer. This first layer may form part of a protective layer as detailed above, or may be independent of the protective layer. When the one or more first devices is independent of the protective layer, it typically lies under the protective layer, such as adhered thereto, i.e. with the protective layer positioned between the first layer and the natural energy source.

In this embodiment, the first layer typically is positioned on top of a second layer, the second layer containing the third device which is able to direct the electricity from the one or more first devices to the one or more second devices. Optionally, if desired, there may be an air gap between the first and second layers, or an air hole to prevent or minimize condensation in high humidity conditions.

In turn, the second layer typically is positioned on top of a third layer (i.e. between the first and third layers), the third layer containing the one or more second devices which are able to store the electricity generated by the one or more first devices.

This third layer is then typically positioned on top of a fourth layer (i.e. between the second and fourth layers), the fourth layer containing the fourth device which is able to distribute the electricity from the apparatus, and being the layer which is most distal from the protective layer and the source of natural energy.

The apparatus of the invention may be contained within a housing, which may comprise any suitable material, particularly materials which are substantially resistant to water damage and corrosion. The housing may comprise a resin material. Alternatively, the housing may comprise a sponge structure having magnetic and heat sink properties. The integrated properties of the housing are designed with the operating environment in mind. For example, where there is a potential build-up of heat, the thermal qualities of the resin can be mixed to be adaptable to this environment.

The housing may have a conductive material located on its exterior, to act as an efficient energy transfer system between adjacent apparatuses. For example, a conductive metal, such as copper, coated with graphene may be located there. The metal may be coated on both sides by the graphene. The metal may be in a mesh form, or in the form of a metal foil. Copper mesh coated with graphene is preferred. This combination provides a particularly efficient energy transfer system.

When the protective layer comprises a material such as a polycarbonate, then the housing may also comprise a polycarbonate. However, when the protective layer comprises a material such as a glass, then the housing typically comprises another material, such as aluminium. When the protective layer comprises glass, the glass may be joined and sealed to the housing material using a laser. The housing material for this may be a metal, such as aluminium. When the laser sealing is employed, no adhesive is required to bond the protective layer to the housing.

According to one embodiment, the apparatus of the invention may have a self-repairing inhibitor located thereon, which partially or completely coats the housing. The inhibitor may act as a sealant, ionically sealing the housing for the apparatus. The inhibitor prevents water and other fluids from entering the housing, and causing degradation of the devices therein, and is also able to prevent or minimize the growth of biological materials, such as algae or the like, on the housing.

A self-repairing inhibitor is able to regenerate itself f any defects form therein. The inhibitors often comprise polymer-based coatings. These work by having micro-containers within the coating, the micro-containers containing monomers which are similar to the polymer matrix and a suitable catalyst or agent that is sensitive to certain conditions (such as e.g. pH), which will initiate the polymerization of the monomer when released at the damaged spot of the coating. When these microcontainers become mechanically deformed, they release the monomer and catalyst, sealing any defect.

The apparatus and/or housing typically possesses robust thermal properties, provided by the inclusion of a fire-retardant material within the apparatus and/or housing. The housing may comprise a resin material containing the fire-retardant material, and facilitates the release of heat out of the apparatus in order to prevent the apparatus from overheating, and reducing any fire risk. The apparatuses may also be housed within nylon foam inserts for impact and fire-resistant protection.

Each individual part of the housing can be made with bespoke qualities, as desired. For example, any desired additive material—such as a material for thermal conductivity and heat dissipation, e.g. graphite, or boron nitride, typically in an adequately dispersed form—may (or may not, as desired) be contained in any part of the housing. This allows there to be variation in the thermal conductive qualities, depending upon a desired function, as well as whatever operating environment the apparatus needs to function within.

According to another embodiment, each apparatus may also comprise one or more light-emitting diodes (LEDs). These LEDs may be positioned around the perimeter of the apparatus. These LEDs can provide lighting which is independent of the power supply of the structure or vessel upon which the apparatus is located, the intensity of which can be controlled depending upon the desired use. The LEDs are able to provide lighting when the level of daylight is not sufficient to provide enough energy to the apparatus for conversion by the one or more first devices. The light emitted will create an ambient and diffused light effect as it will be diffused by the protective first layer, and the lighting may only be activated when the apparatus is not generating energy. However, in the event of a power loss or in an emergency situation, the LEDs can be activated, when a management system for the apparatus, controlled by a printed circuit board can override the harvesting of solar energy and provide energy to the LEDs.

The use of a light guide may be employed to reduce reflective loss. The use of a light guide or optic concentrator device, such as a luminescent solar concentrator (LSC), is also for concentrating radiation, solar radiation in particular, to produce electricity, by self-absorbing the light into the PV module, recovering around 10-30% of the light as energy.

The one or more first devices may be covered with a thin mini or micro Fresnell or bespoke light concentrator lens or, may be used without any lens attachments. The dual use of a reflective lens is also for the dispersion of light created by the LED integrated within the layer containing the one or more first devices.

The apparatus of the invention may be any shape or dimension desired, either in order to fit in with the area it is located within, or for simple aesthetics in the environment it is to be placed. There may also be half-shapes that have facet shaped tiles to be used at the edges of arrays to make, for example, the transition of a ship's deck system smooth with the lower deck structure to avoid trip hazards or uneven siting of the deck space, where there may be other deck furniture such as hatches. Surrounding deck areas that provide suitable run-off of any deck water or which prevent water ingress will remain faithful in height level where there may be the risk of creating standing water or pools of water where the deck is uneven or there is an issue with height restriction. The apparatus is typically of a recognized geometric shape, such as a hexagon, square or rectangle, which allow for the greatest degree of interconnection and surface coverage using the apparatuses; however, it may also be in an irregular, non-geometric shape, or any shape which still allows for an effective coverage of the surface the apparatus is to be attached to. The apparatuses may also be manufactured in clusters for integrated attachment directly onto a surface.

In one embodiment, where the apparatus has a geometric shape, such as a hexagon, the first devices, such as PV cells, may be present on all sides of the apparatus, or alternatively, may be present on adjacent or alternating vertical sides, with the other sides which are free of the first device(s) instead having a reflective or mirrored surface thereon.

According to one embodiment, underneath the first device there may be an amount of a reflective material, which may be in the form of a bespoke arrangement of PV cells, or a reflective material, such as but not limited to, aluminium sheeting with high reflective finish. Other metals or materials with high levels of light reflectance could also be used as the reflective base. This reflective base aids in the capture of the solar energy, by reflecting light back upwards so that it may be captured by the one or more first devices. The reflective material is typically positioned between the first device and the third device.

In one embodiment of the invention, the third device may be positioned approximately centrally in the apparatus, as viewed from above. LED lights may be arranged around the periphery of the apparatus, and around the third device.

The apparatus may also comprise dyes and quantum dots embedded within the layer structure. The quantum dots may comprise inorganic halide perovskite materials, such as those comprising CsPbBr₃ and K₂SiF₆. These enable light spectrum enhancement and harvesting for the increased capture of solar energy. Inorganic halide perovskite quantum dots (QDs) have been considered as a promising substitute for white light-emitting diodes (WLEDs).

Another arrangement envisaged within the invention includes the passive use of solar harvested energy together with a hydrogen converting membrane that would convert sea water that had been purified into hydrogen and oxygen for storage.

When the apparatus is used to generate electricity from hydropower, the hydrogen content stored in the apparatus is less than about 5%. Any level above this is dangerous in an open structure. It is released by electrical or chemical induced charge from the storage device or, if the hydrogen is generated at higher levels, by removal of the storage device manually as a fuel cell. These cells can vary in height as well as width. The generated hydrogen can be used with a fuel cell or as part combustible materials for gas or other fuel into a traditional engine or generator. The removable hydrogen device can be re-used and stored separately for later use. The charge level is recorded by the PCB within the apparatus, with information provided either on the apparatus or digitally to a device, such as a phone app.

According to one embodiment of the present invention, two or more apparatuses of the invention may be reversibly connected together to form an array. There may be any number of apparatuses in an array, suitable and capable of providing the pre-designed energy requirement, employed together in the generation, storage and distribution of power, with the fourth device acting as an energy distribution system to distribute the electricity stored in the second device across the array.

Hydrogen-generating apparatuses may be mixed amongst those using solar power, and they may be used in any combination or arrangement. They may also be used in increased volume at water contact levels, where there is a greater likelihood of contact with water, such as on the side of a marine vessel.

In the array, the apparatuses are electrically connected to each other, so electricity can flow freely from one apparatus to any other that it is connected to. In one embodiment, there may be an amount of a conductive metal, such as copper, and/or graphene, and/or boron nitride, or a composite of both graphene and boron nitride, on one or more sides of the apparatus, in order to enhance the electrical connectivity between adjacent apparatuses when they are connected together as part of an array. The copper may be coated with graphene, and/or it may be in the form of copper mesh. The presence of these materials facilitates the electrical connection between connected apparatuses, and acts as a very efficient energy transfer system.

In one embodiment, each array, or cluster, may contain up to about 12 individual apparatuses, or up to about 10 or 8 individual apparatuses. One exemplary array may contain 7 individual apparatuses. Each array is typically positioned on a vessel in a patchwork pattern around it, for example at the sides of a deck or at the ends of the vessel, in such a manner that each array is not directly connected to each other. The apparatuses need not cover the entire surface they are connected to.

The individual apparatuses may be connected together by any suitable means, such as magnets, or a mechanical connection such as a bracket, or using a bonding or connecting conductive material.

When adjacent apparatuses are connected together by magnets, the magnets may be located within a wall of the housing. If desired, there may also be a hard connection using more established materials—depending on the environment this system will operate.

The arrays can operate in different ways: either with capacitors to upscale energy for instant deck-based use; or they can be set up for storage where they can be used for hotel load power, i.e. power required after the available natural light is no longer sufficient for the generation of now electricity, and the battery energy must provide this energy overnight through the discharge of the batteries.

The electrical energy collected by each apparatus is transferred to an adjacent apparatus containing a battery in sequence and collects power cumulatively until it reaches an energy management cell. As used herein, the term ‘energy management cell’ means a cell which controls the flow of electricity across an array of apparatuses according to the invention. These energy management cells provide the management of energy between the energy creation device—i.e. the one or more first devices—and the energy use and distribution device—i.e. the fourth device. These management cells are separated thermally and housed in sealed units to manage the energy as it is moved to where is it is locally required, such as either on deck or integrating into existing electrical systems within a vessel. The energy management cells are non-solar, i.e. they do not themselves generate electricity from a natural energy source. These non-solar cells can be used for wireless charging points, but for drones and other electrical equipment used on a working ship. One energy management cell is able to control a large number of apparatuses of the invention, for example between about 100-150 individual apparatuses. The energy management cell typically comprises a PCB and a power storage facility, such as one or more batteries.

The battery can be a standard cell phone sized battery or, it can be a larger battery in size and output, using variable but individual specified lithium ion, lithium sulphur, zinc oxide or any other advanced battery which is available through mass production. It can also vary in shape and depth to accommodate the varying shape of the apparatus (e.g. hexagonal) and depth; and may employ a liquid electrolyte. Further enhancement of the system may include the development and structural integration of a centralized flow battery system. These battery-containing apparatuses will be self-contained and fit to meet the required size of the battery supplied, lined with fire retardant such as, but not exclusively nylon-based foam materials as well as insulation materials, that make each thermally insulated. The apparatus of the invention is able to charge these batteries using the generated electrical energy.

The energy management cell typically comprises a PCB, which manages and directs any harvested energy into a locally connected and separate battery tile and allows the sensing and management of this energy to be reported to a centralised or specialized control unit, which can either be accessed through a smart phone app, or can be used with inbuilt navigation panels within an existing ship structure, such as on the instrument panel via a liquid crystal display (LCD) screen. Sensors on the PCB will record and regulate the level of power within battery clusters, and they will measure available power and provide information of how long this power can be used at its current discharge rate. There will typically a minimum of two recharges for the battery cells per 24-hour cycle. The power generated will be spread across the connected battery clusters to provide even charging.

The energy management cell's PCB also acts as a gateway for the collection of the harvested energy within each battery cell cluster, allowing current stabilization and thermal management across the deck, it also controls the flow of energy to be spread across the deck to be used as where and when required. It also provides a safety break point for the detection of irregular temperature occurrences at a very local level before it causes a problem. The management cell also contains the emergency gateway shut off point for any part's failure, overheating, or over-charging of the battery, and this is controlled through the PCB.

The energy management cells are also typically lined with a fire-retardant material such as, but not exclusively nylon-based foam materials as well as insulation materials, that make each of them thermally insulated.

Any space between individual apparatuses in an array may be filled with a latticework of composite materials, that include but are not limited to graphene oxide and aluminum, which may be contained in a rubberized material, which will provide cushioning and reduce friction by having a flexible sponge like quality that allows for some movement and impact. This open space can also act as a heat sink allowing release of heat.

The apparatus may be attached to a surface by any suitable means, which will depend upon the nature and material of any given surface. Suitable means may include, but are not limited to, natural or advanced adhesives, or depending on superstructure, bolts or screws. All apparatuses are waterproofed using composites and resin materials, and these materials have certified and variable good thermal and low conductive qualities.

Water may be pumped around the deck structure for cooling the apparatuses of the invention and cleaning their surfaces.

The apparatus and arrays of apparatuses are able to move vertically and horizontally within the definitions and expectations of specific structures. All of the apparatuses have the conductive sub-layer in the fourth device at approximately the same height, thus allowing maximum contact and efficiency of energy transfer. How the individual apparatuses are connected together, such as with magnets, also allows vibrational interference not to weaken the structure and allows a controlled amount of movement laterally when mounted on a flexible resin surface.

When in operation, the apparatus of the invention may be positioned so that it does not lie flat and in contact with a surface; rather, it may be positioned such that there is a small gap between the apparatus and the surface. For example, when the surface is a deck of a marine vessel, the presence of such a gap allows for the drainage of any accumulation of water on the deck, and also the introduction of water for apparatuses which require it to generate hydrogen.

Overall, the present invention allows power to be generated, stored and used locally in an efficient and effective battery-based power grid apparatus that can be bespoke to specific requirements. It also comprises a facility to monitor amounts of energy that are being stored in and/or used by the apparatus, which can be carried out remotely by, for example, an app. One way the invention can be bespoke is through the use of removable tiles or panels comprising the apparatus of the invention. The tiles or panels can be changed and updated to maximise energy capture depending on the specific needs of a user, and the specific structure they are to be used on, or to be specific with power use or storage requirements. This system also allows for future enhancements in technology to be quickly introduced and integrated into the existing structure. It is important to note that the conductive sub-layer in the fourth device will be an effective structural base for the devices above it. The housing, should it become damaged, can be repaired by epoxy resin and colour matched to minimize any loss of consistency in finish and performance.

The fourth device may also provide an integrated network of sensors that can provide structural information regarding the integrity of the structure they are attached to. This can be operated and powered via the second device. The one or more sensors may be used as ongoing recording of data in an autonomous ship for example, or, be part of a routine inspection during a vessel's lifecycle. The one or more sensors may be directly connected to the surface or deck to which the apparatus is fixed, via an opening in the lower sub-layer of the fourth device which is positioned directly below the one or more sensors on the conductive sub-layer. The type of sensors may be selected for the appropriate use of the software system attached to the system and the level of data required to be recorded. The one or more sensors will be suitable for harsh environment operation and may contain graphene and silicon materials.

The energy from solar power will typically be generated as DC current, as is the case with all PV cells. It will be stored and used in this arrangement. Levels of solar energy may be able to provide propulsion energy feeding directly fed DC power into the new build generation of ship design that is built around electrical systems using DC only supply, which to power heavier equipment is more efficient. The maximum deck operating power level of the deck system will be 48V and minimum of 12V in most arrangements; this is designed around the transfer of technology from other transport sectors into marine where management and autonomous navigation systems will require a separate and reliable back up energy system should their systems be broken.

The apparatus of the invention is durable, conductive for heat and electricity, as well as being substantially both waterproof and fireproof The apparatus of the invention:
is low maintenance;
provides a continued renewable energy supply;
includes power storage and energy on tap;
can capture low light energy;
is easily updated for new technology;
integrates with other wireless technology;
can be retrofitted or new fit;
can be used as an emergency energy supply;
will only improve in efficiency in the future;
can be fitted at any size or available space; and
provides a bespoke approach to producing energy

Also envisaged within the present invention is that wireless charging may be possible from the tiles. This may be achieved using another layer of a conductive composite material in place of the one or more first devices are able to convert energy from a natural source, such as solar power, into electricity. This can be used for the charging of e.g. drones on fishing boats, or minor electrical equipment. It works by using a radio frequency identification (RFID) tag that communicates with the device to be charged and allows the right charge voltage to be released through the charging plate. The charging plate will be conductive using electromagnetic current through the top plate, making it safe around water, unless used with an electromagnet.

Also envisaged is the inclusion of an apparatus or tile—in a ratio of one per every several hundred of apparatuses of the invention—which is able to detach from the marine vessel and float, and send a GPS signal from its location. This is in case the marine vessel sinks. In this way, the vessel can be traced via signal on the surface of the water.

The apparatus of the invention may also help in the charging of lifesaving equipment such as inflatable lifejackets and dinghies for rescue equipment. These devices can be stored in a permanent state of charge, or charged by supercapacitors within minutes for emergency deployment for larger items.

The apparatus of the invention can also be produced in addition shapes, including rectangles, triangles, or more irregular shapes, and can be used with other apparatuses of different scales and sizes. For example, a single apparatus can be attached to a larger cluster of apparatuses to form a network. Apparatuses can contain a variable size of PV units and be larger or smaller than a standard size.

The apparatuses may also be finished in a variety of colours and finishes, including wooden finishes, slate or basalt finishes and any shade of available colour finish in matt or gloss that can be applied to a polyester based resin. This may or may be part of any coatings applied to its surface.

Any apparatuses which may be mounted along the sides of a marine vessel may or may not contain a battery or any kind of energy storage device. They may display through LED lighting effect, logos or names of ships, brands etc., displayed along the hull of the vessel or any part of the lower hull structure.

The apparatus of the invention may be supplied for fitting with additional security measures, including, but not limited to, conductive coverings, to retain a level of battery charge in transit and protective sleeves over the tiles to prevent marking or scratching.

According to another embodiment of the invention, there is provided a marine vessel comprising one or more apparatuses as defined hereinabove.

According to another embodiment of the invention, there is provided a use of one or more apparatuses as defined hereinabove in the generation and storage of power, particularly electrical power.

The present invention also provides a method of generating and storing power comprising employing one or more apparatuses apparatus as defined hereinabove.

The invention will now be described further by way of example with reference to the following figures which are intended to be illustrative only and in no way limiting upon the scope of the invention.

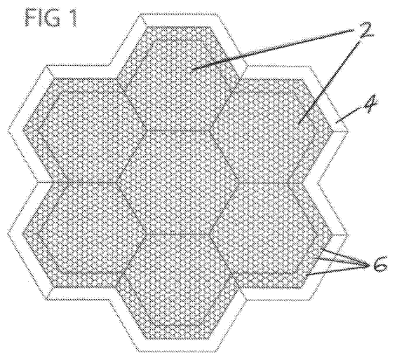

FIG. 1 depicts a cluster of seven apparatuses of the invention joined together from above;

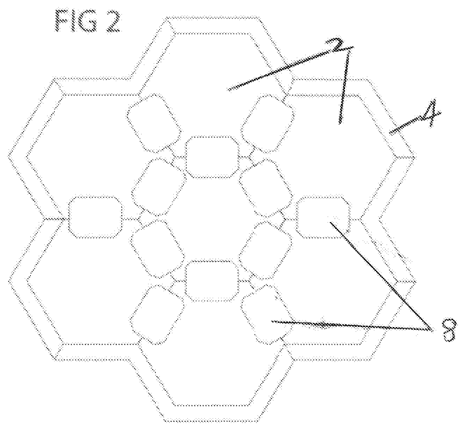

FIG. 2 depicts a cluster of seven apparatuses of the invention joined together from underneath; and

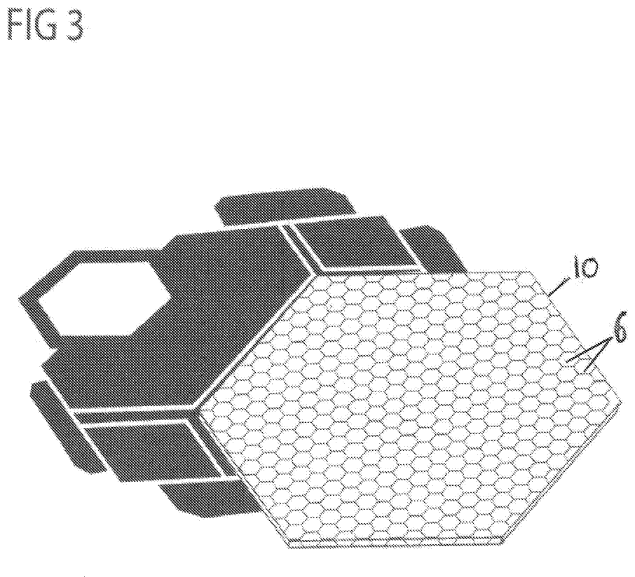

FIG. 3 depicts an assembly of an apparatus of the invention with a top tile and lower tile assembly.

In FIG. 1, a small cluster of seven apparatuses 2 of the invention joined together is shown from an overhead perspective. The apparatuses have a hexagonal shape, purely for ease of combining and joining a number of them together, and together they form a neat geometrical shape. Surrounding the cluster of apparatuses is an edging 4.

On each apparatus can be seen a number of PV cells 6 to absorb the solar radiation.

In FIG. 2, the same small cluster of seven apparatuses 2 of the invention joined together is shown from an underneath perspective. The apparatuses are connected by connecting means 8.

In FIG. 3, the first layer 10 with the PV cells 6 is shown over the lower layers, to give a perspective on how the layers and the adjacent apparatuses are connected together to form an array.

It is of course to be understood that the present invention is not intended to be restricted to the foregoing examples which are described by way of example only.

1. An apparatus for the conversion of power from a natural energy source into electricity, and the storage and distribution of the electricity, the apparatus comprising:
i) one or more first devices able to convert power from a natural energy source into electricity;
ii) one or more second devices able to store the electricity generated by the one or more first devices;
iii) a third device able to direct the electricity from the one or more first devices to the one or more second devices;
iv) a fourth device able to distribute the electricity from the apparatus.

2. The apparatus according to claim 1, wherein the one or more first devices comprise one or more photovoltaic cells, and/or a hydrogen fuel cell.

3. The apparatus according to claim 1, wherein the one or more first devices comprise a perovskite material.

4. The apparatus according to claim 1, wherein the second device comprises one or more batteries and one or more supercapacitors, or one or more devices for storing hydrogen.

5. The apparatus according to claim 4, wherein the one or more supercapacitors comprise one or more materials selected from one or more perovskite compounds, one or more metal oxides, nanotubes of a conductive material or metal oxides, an aqueous graphene-enhanced material, or an amount of a bismuth-containing material.

6. The apparatus according to claim 1, wherein the third device comprises a printed circuit board.

7. The apparatus according to claim 1, wherein the fourth device comprises three sub-layers therein.

8. The apparatus according to claim 7, wherein the sub-layers include an electrically conductive sub-layer sandwiched between a second sub-layer and a third sub-layer, both second and third sub-layers being substantially electrically non-conductive.

9. The apparatus according to claim 8, wherein the conductive sub-layer comprises copper and/or a composite alloy material.

10. The apparatus according to claim 9, wherein the composite alloy material comprises one or more of a rare earth magnetic metal, copper, copper oxide, graphene, graphene oxide, cobalt and/or nickel.

11. The apparatus according to claim 8, wherein the electrically conductive sub-layer comprises a flexible conductive mesh structure.

12. The apparatus according to claim 1, wherein the apparatus is in the form of a tile or panel.

13. The apparatus according to claim 1, further comprising a layer of a protective material protecting the apparatus from its environment.

14. (canceled)

15. The apparatus according to claim 13, wherein the one or more first devices are either contained within the protective material or are positioned underneath it.

16. The apparatus according to claim 1, wherein the apparatus comprises quantum dots and/or a dye material.

17. The apparatus according to claim 1, wherein the apparatus has a layered structure, with the one or more first devices being positioned proximal to the natural energy source and forming a first layer; the third device being positioned underneath the one or more first devices and forming a second layer; the one or more second devices being positioned underneath the third device and the one or more first devices and forming a third layer; and the fourth device being positioned distal to the natural energy source and underneath the first, second and third devices and forming a fourth layer.

18. The apparatus according to claim 1, wherein the apparatus comprises a housing containing the first, second, third and fourth devices, the housing comprising a resin material containing an amount of one or more of graphene oxide, boron nitride, fire retardant additives, carbon black and/or graphite.

19. The apparatus according to claim 18, wherein the housing comprises a conductive material and/or a self-repairing inhibitor located on its exterior.

20. An array comprising a plurality of apparatuses according to claim 1 interconnected with each other.

21. The array according to claim 20, wherein electrical power is stored in a battery located within a battery cell.

22. The array according to claim 20, wherein the array is operated in conjunction with one or more energy management cells, the one or more energy management cells each comprising a printed circuit board, which controls the flow of electricity across the array.

23. A marine vessel comprising one or more apparatuses according to claim 1.

24. A method of generating and storing power comprising employing one or more apparatuses according to claim 1.

25. (canceled)
